(19) United States
(12) Patent Application Publication
(10) Pub. No.: US 2005/0111653 A1
(43) Pub. Date: May 26, 2005

(54) Instant message processing in a customer interaction system

(76) Inventors: Robert Joyce, San Jose, CA (US); Prabhuram Mohan, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/447,250

(22) Filed: May 27, 2003

Related U.S. Application Data
(60) Provisional application No. 60/463,167, filed on Apr. 15, 2003.

(51) Int. Cl. H04M 3/00; H04M 5/00; G06F 3/00; G06F 9/46

(52) U.S. Cl. 379/265.09; 719/318

(57) ABSTRACT

A method and apparatus is provided to process an instant message call within a customer interaction system. The method includes receiving the instant message call at the customer interaction system and processing the instant message call within the customer interaction system with other interaction types based on information associated with the instant message call.

### RELATED INVENTIONS

This application claims the benefit of U.S. Provisional Application No. 60/463,167, filed Apr. 15, 2003.

### FIELD OF THE INVENTION

The present invention relates generally to the field of communications and, more specifically to the allocation of an instant message call to an agent.

### BACKGROUND OF THE INVENTION

Customers will use different media types to communicate with agents of an organization. For instance customers may place a telephone call, initiate a web chat, or send an email to the organization. In response, an agent of the organization provides service or support, usually by communicating via the media type chosen by the customer.

Connecting the customer to the agent requires processing the incoming call in a manner that assigns an available agent based on a number of factors including the media type chosen by the customer. For instance, a voice call may be immediately allocated to an agent while an email may be queued until other calls are serviced first.

Recently, instant messaging services have grown in popularity, especially among the young. Consequently, businesses could benefit by including an instant messaging communication path that is integrated together with existing communication paths to respond to the enquiries of their customers.

### SUMMARY OF THE INVENTION

A method and apparatus is provided to process an instant message call within a customer interaction system. The method includes receiving the instant message call at the customer interaction system and processing the instant message call within the customer interaction system with other interaction types based on information associated with the instant message call.

The invention extends to a machine-readable medium for storing instructions that, when executed by the machine, cause the, machine to execute any one of the methods described herein. Other features of the present invention will be apparent from the accompanying drawings and from the detailed description which follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating a system, according to an exemplary embodiment of the present invention;

FIG. 2 is a block diagram illustrating hardware and software components, according to an exemplary embodiment of the present invention;

FIG. 3 is a block diagram illustrating hardware and software components in a multimedia customer interaction machine, according to an exemplary embodiment of the present invention;

FIG. 4 is a block diagram illustrating a blended live-agent work area, according to an exemplary embodiment of the present invention;

FIG. 5 is a block diagram illustrating task messages, according to an exemplary embodiment of the present invention;

FIG. 6 is a block diagram illustrating an instant message task queued message, according to an exemplary embodiment of the present invention;

FIG. 7 is an entity relationship diagram illustrating entity relationships, according to an exemplary embodiment of the present invention;

FIG. 8 is a database schema diagram illustrating tables in the customer information database, according to an exemplary embodiment of the present invention;

FIG. 9 is a flow chart illustrating a method, according to an exemplary embodiment of the present invention, to receive the instant message call at the customer interaction system;

FIG. 10 is a flow chart illustrating a method, according to an exemplary embodiment of the present invention, to process the instant message call within the customer interaction system with other interaction types;

FIG. 11 is a flow chart illustrating a method to receive an instant message call at the multimedia customer interaction machine, according to an exemplary embodiment of the present invention;

FIG. 12 is a flow chart illustrating a method, according to an exemplary embodiment of the present invention, to process a blended live-agent becoming available to work on a task;

FIG. 13 is a flow chart illustrating a method, according to an exemplary embodiment of the present invention, to allocate an instant message call to a blended live-agent;

FIG. 14 is a flow chart illustrating a method to allocate an agent to a task, according to an exemplary embodiment of the present invention;

FIG. 15 is a flow chart further illustrating a method to queue a task, according to an exemplary embodiment of the present invention;

FIG. 16 is a flow chart illustrating a method to allocate an agent available for work, according to an exemplary embodiment of the present invention;

FIG. 17 is a flow chart further illustrating a method to allocate an available agent available workflow, according to an exemplary embodiment of the present invention;

FIG. 18 illustrates user interface screens, according to an exemplary embodiment of the present invention, as viewed by the customer;

FIG. 19 illustrates user interface screens, according to an exemplary embodiment of the present invention, as viewed by a blended live-agent; and

FIG. 20 shows a diagrammatic representation of a machine in the exemplary form of a computer system within which a set of instructions for causing the machine to perform any one or more of the methodologies discussed herein, may be executed.

### DETAILED DESCRIPTION

A method and system to process an instant message call within a customer interaction system are described. In the following description, for purposes of explanation, numerous specific details are set forth in order to provide a thorough understanding of the present invention. It will be evident, however, to one skilled in the art that the present invention may be practiced without these specific details.

In general, embodiments described below feature a customer interaction system that receives and processes an instant message call with other interaction types based on information associated with the instant message call. In one embodiment, the instant message call is processed at a customer interaction system comprised of media specific customer interaction systems and a multimedia customer interaction system. The media specific customer interaction system associated with instant message calls receives and immediately forwards the instant message call to the multimedia customer interaction system for allocation to a live blended agent. The multimedia customer interaction system allocates a blended live agent to process the instant message call with regard to the workload distributed across all the media specific customer interaction systems, the skills needed to process the call, the importance of the customer making the call, and other factors as the enterprise may define in customizable business logic. In particular, the destination of the instant message call (e.g., specified by an instant message screen name) can be used for routing, queuing and prioritizing the call. Accordingly, the multimedia customer interaction system processes an instant message call blended (or commingled) with other messages received over other media or utilizing other messaging on communication systems via common infrastructure and tools based on customizable business logic.

In another embodiment, the instant message call is processed at the media specific customer interaction system without forwarding to the multimedia customer interaction system for allocation to a live agent. For example, the media specific customer interaction system associated with instant message calls would respond to an incoming instant message call by allocating an automated agent. The automated agent might interact with the caller by answering questions and prompting the caller for additional information when necessary. In this example, the automated agent would conclude the instant message call without forwarding to the multimedia customer interaction system. Alternatively, in another example, the automated agent might interact with the caller only until a live agent becomes available. In response to the live agent becoming available the automated agent would conclude its dialogue with the caller and forward the instant message call to the live agent along with any information that was collected by the automated agent.

Thus, in the embodiments described above, the customer interaction system might process the instant message call in both the media specific customer interaction system and the multi-media customer interaction system. Processing the instant message call in the media specific interaction system is based on information associated with the instant message call in the exemplary form of the instant message caller's identity, transaction history, service history, customer profile, responses, queries, the identity of the called party as provided by a screen-name that identifies a name (e.g., Joe Francis) or service (e.g., FidelityRetailService or ChryslerSales)), live agent availability, etc. Whether the automated agent is able to complete the instant message call is substantially determined by the information associated with the instant message call, which includes information gleaned from the dialogue between the caller and the automated agent as noted above.

Processing in the multi-media customer interaction system is also based on information associated with the instant message call; however, in the multi-media customer interaction system the information associated with the instant message call also includes the media type, live agent availability, live agent skills and skill levels, etc. Further, processing in the multi-media customer interaction system requires that the instant message call compete with calls of other media types for a blended live-agent.

### Architecture

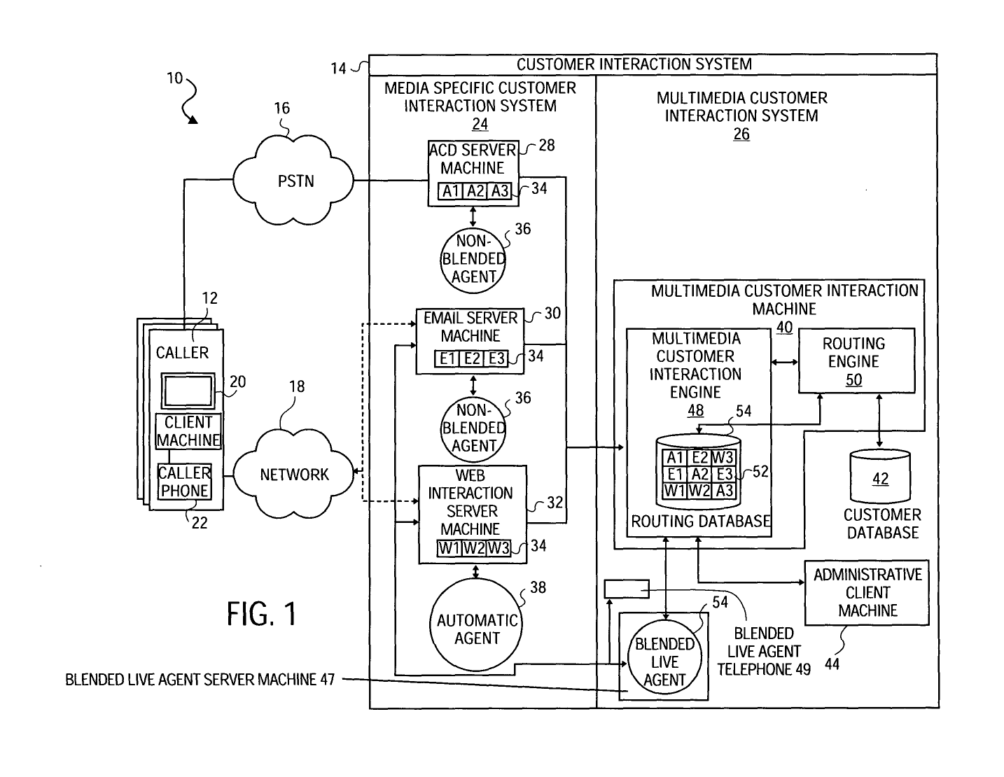

FIG. 1 is a block diagram illustrating a system 10, according to an exemplary embodiment of the present invention, to process an instant message call. The system 10 includes a customer interaction system 14, a client machine 20, a Public Switch Transport Network (PSTN) 16, and a network 18.

A caller 12 is coupled to the customer interaction system 14 by either the PSTN 16 or the network 18 or both. Each caller 12 has one or more of: (1) a client machine 20 that connects to the Customer Interaction System 14 via the network 18 (2) a telephone that connects to the Customer Interaction System 14 either via the PSTN (traditional voice telephony) or via the network (IP telephony). The caller 12, seated at the client machine 20 and next to the caller telephone 22, may utilize the caller telephone 22 or services available through the client machine 20 to connect to and interact with an agent exclusively dedicated to a specific media type (non-blended agent) coupled to a media specific customer interaction system or an agent capable of processing multiple media types (blended agent) coupled to a multimedia customer interaction system.

The customer interaction system 14 includes a media specific customer interaction system 24 and a multimedia customer interaction system 26. The media specific customer interaction system 24 includes an automatic call distribution (ACD) server machine 28, an email server machine 30, and a web interaction server machine 32. Each media specific customer interaction system 24 includes a media specific queue 34 utilized to queue media specific calls that originate from the caller 12 and are queued for allocation to an available automated agent 38. Further, each media specific customer interaction system 24 services calls for one or more exemplary interaction types in the form of media types. For example, the ACD server machine 28 services calls in the form of telephone calls; the email server machine 30 services calls in the form of emails; and the web interaction server machine 32 services calls in the form of web interaction requests and/or instant message requests. The web interaction server machine 32 responds to the web interaction request by providing web chat and web navigational services (e.g., one party, the caller or agent, may use a browser to navigate to a web page on the WWW while a remote browser displays the same web page to the other party). The web interaction server machine 32 responds to the instant message request by providing instant message services. Finally, the web interaction server machine 32 is coupled to an automated agent 38.

The multimedia customer interaction system 26 includes a multimedia customer interaction machine 40 that is coupled to a customer database 42 via a routing engine 50, an administrative client machine 44, and a blended-live-agent server machine 47 where a blended live-agent 46 and an agent telephone 49 are located. The multimedia customer interaction machine 40 includes a multimedia customer interaction engine 48, a routing engine 50, a unified queue 52, and a routing database 54.

In the exemplary embodiment, the caller 12 initiates a call from the client machine 20 or the caller telephone 22 that is serviced by the respective media specific customer interaction system 24 based upon the media types as selected by the caller 12. The respective media specific customer interaction system 24 receives the request in the form of a task and attempts to assign the task to a local non-blended agent 36. In the event that the task cannot be assigned to the non-blended agent 36 or forwarded by the non-blended agent 36, the task is queued at the media specific queue 34 and a request is communicated to the multimedia customer interaction system 26. The multimedia customer interaction system 26 attempts to allocate the task to an available blended-live-agent 46. In the event that the task cannot be allocated to the blended-live-agent 46 the task is queued at the unified queue 52 where it waits for an available agent (e.g., non-blended agent 36 or blended live-agent 46). Thus, a task may be allocated to an available agent at the media specific customer interaction system 24 or the multimedia customer interaction system 26.

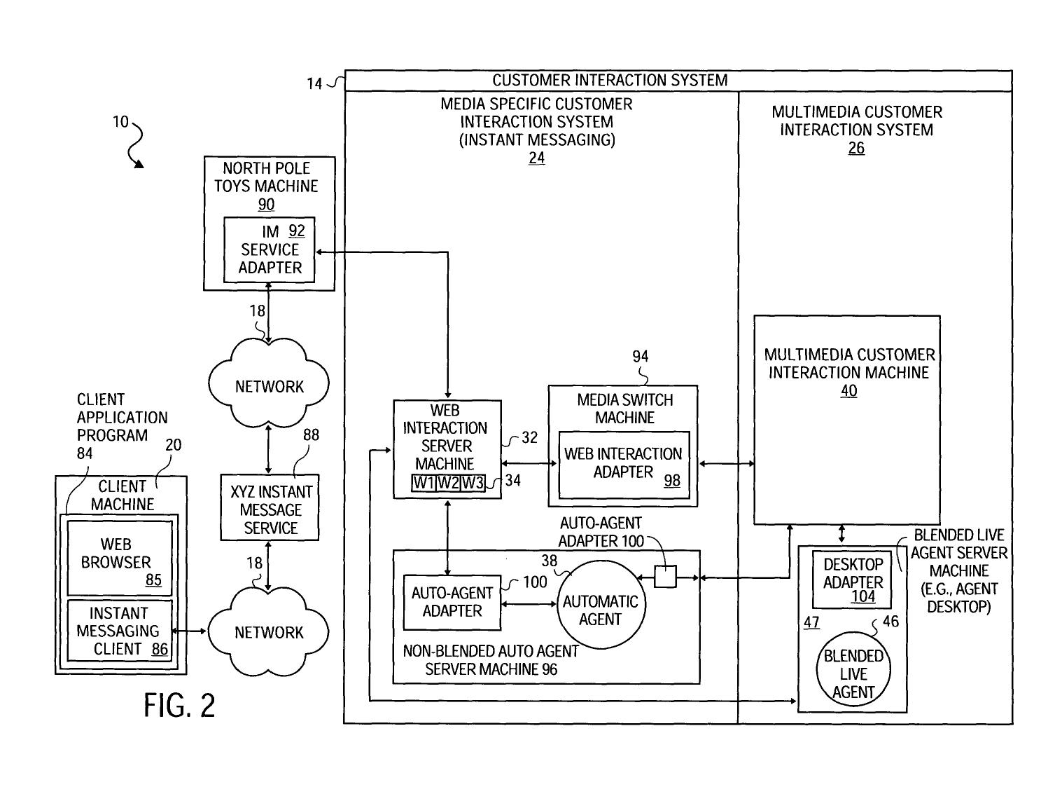

FIG. 2 is a block diagram illustrating hardware and software components of the system 10, according to an exemplary embodiment of the present invention.

The client machine 20 includes a client application program 84 that may take the form of a web browser 85 or an instant messaging client 86. The caller 12 at the client machine 20 may utilize the web browser 85 to load the instant messaging client 86. In one embodiment, a user at the client machine 20 may initiate an instant message session from the instant messaging client 86. In another embodiment, a user at the client machine 20 may initiate the instant session by selecting a link that is displayed by the web browser 85 and launches the instant messaging client 86.

The instant message service 88 enables the real time exchange of text messages between two users that are identified by screen names. For example, an instant messaging service may take the form of the America Online Instant Messenger (AIM®) provided by America Online, a Time Warner Company of Delaware, New Jersey; or, MSN Messenger® provided by Microsoft of Redmond, Wash. and the National Broadcasting Company of New York, N.Y.; or the Yahoo's! Messenger® provided by Yahoo Inc. of Santa Clara, Calif.

In the present example, the caller at the client machine 20 is connected to the customer interaction system 14 over an instant message service 88 utilizing the below described hardware and software components. The caller 12 at the client machine 20 signs on to the instant message service 88 and provides a screen name in the form of a buddy name to the instant message service 88. The buddy name identifies another party or service that is presently signed on to the instant message service 88, in this example, the North Pole Company. The North Pole Toy's machine 90 includes an instant messaging service adapter 92, which communicates with the instant message service 88 and the web interaction server machine 32 at the media specific customer interaction system 24.

The media specific customer interaction system 24 includes the web interaction server machine 32, the media switch machine 94 and the non-blended auto-agent server machine 96. The web interaction server machine 32 communicates with the non-blended auto-agent server machine 96 and a media switch machine 94. The non-blended auto-agent server machine 96 includes an auto-agent adapter 100 that is utilized to communicate with the non-blended auto-agent server machine 96. The media switch machine 94 includes a web interaction adapter 98 that communicates with the web interaction server machine 32 and the multimedia customer interaction machine 40. Further, the blended live-agent 46 communicates with the web interaction server machine 32 to retrieve an assigned task in the form of a web interaction call or an instant message call.

Adapters in the form of the web interaction adapter 98, the auto-agent adapter 100, the desktop adapter 104 and the Instant Message service adapter 92 each provide connectivity and application independence between the various applications described above. Consequently, core software in the multimedia customer interaction system 26 may remain unchanged notwithstanding the addition or revision of software components in the media specific customer interaction system 24.

The present example illustrates adapters as utilized by the web interaction server machine 32; however, it will be appreciated that each server type in the media specific customer interaction system 24 includes adapters that are similarly positioned and connected to provide similar functionality. Further, each adapter may include an adapter layer that provides a common set of messages across all media types (e.g., telephone, email, web interaction, instant messaging, etc.) preserving respective application independence. In the exemplary embodiment messages are bundled into the Simple Object Access Protocol “SOAP” message format and communicated over HTTP; however, communication may be facilitated with any agreed protocol. Further, the exemplary embodiment uses extensible markup language (XML) to create files in the Web Services Description Language (WSDL) format that define the services provided. Other embodiments may use other markup languages and file formats.

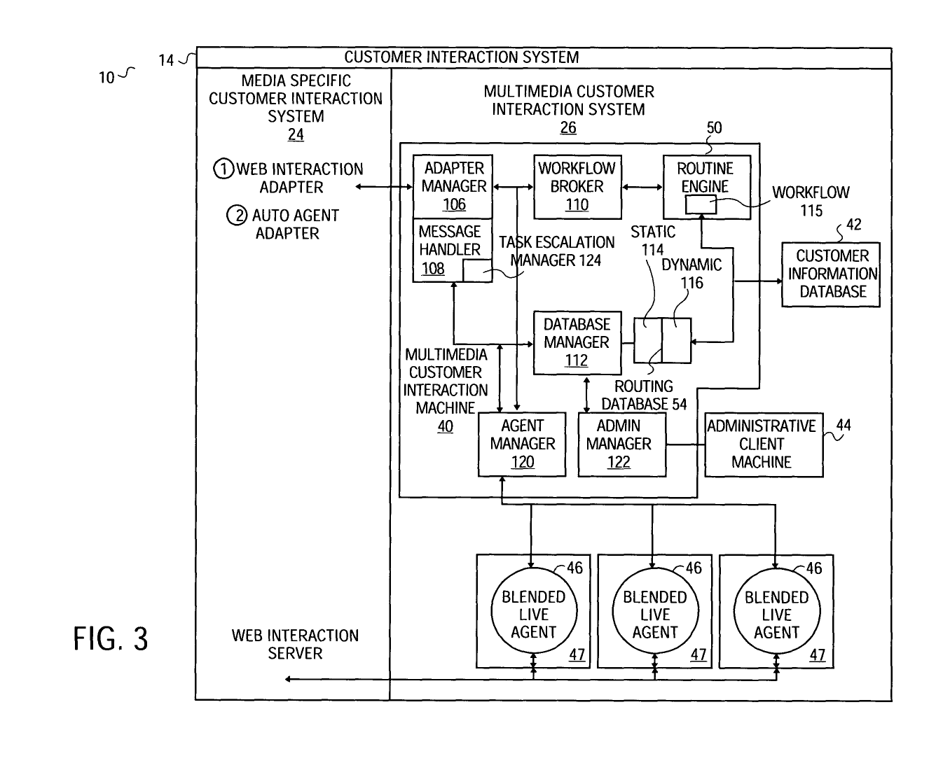

FIG. 3 is a block diagram illustrating the software and hardware components in the multimedia customer interaction machine 40, according to an exemplary embodiment of the present invention. The multimedia customer interaction machine 40 includes an adapter manager 106, a message handler 108, a workflow broker 110, a database manager 112, an agent manager 120, an administrative manager 122, and the routing engine 50.

The adapter manager 106 functions as a communication hub between the media specific adapters in the media specific customer interaction system 24 and the message handler 108. The adapter manager 106 manages adapter connection and disconnection, provides call control interaction, and dispatches messages to the message handler 108.

The message handler 108 receives messages passed on by the adapter manager 106 and forwards them to the agent manager 102, insures that task information in the routing database 54 is current, invokes exemplary business logic in the form of a workflow 115 for task arrivals via the workflow broker 110 and offer tasks to the agent manager 120. The message handler 108 further includes a task escalation manager 124. The task escalation manager 124 reevaluates a queued call at a predetermined time after the call has arrived thus providing an escalation method for calls that are waiting in the unified queue 52 for an agent. The task escalation manager 124 maintains a schedule of unrouted calls to be escalated. The task escalation manager 124 reevaluates a call by executing the workflow 115 associated with task escalation thereby pushing a call to the blended live-agent 46 and not waiting for the blended live-agent 46 to pull the call to it to itself in the form of an agent available for work request. Further, a task can be scheduled for escalation if a task previously allocated to the blended live-agent 46 is subsequently rejected by the blended live-agent 46. The task escalation manager 124 operates by notifying the message handler 108 which notifies the workflow broker, which in turn notifies the routing engine 50 to execute the escalation workflow 115.

The workflow broker 110 receives messages from the message handler 108. The workflow broker 110 communicates with the routing engine 50 to broker requests and responses between the routing engine 50 and other applications. The workflow broker 110 receives three types of requests including a task arrival event from the adapter manager 106, a task escalation event from the adapter manager 106 and an agent available for work request from the agent manager 120. The workflow broker 110 utilizes the content of these messages to determine the events and parameters to send to the routing engine 50 thereby triggering execution of the correct workflow 115.

The agent manager 120 manages communication between the multimedia customer interaction machine 40 and each of the blended live-agent server machines 47.

The database manager 112 manages the routing database 54, which includes a static routing database 114 and a dynamic routing database 116. The database manager 112 provides open database connectivity (ODBC®) between the components of the multimedia customer interaction machine 40 and the routing database 54. ODBC® is a standard database access method, developed by Microsoft Corporation of Redmond, Wash., that enables access to stored data from any application program regardless of the database management system selected to manage the stored data.

The static routing database 114 includes persistent information in the form of agent configuration information, media configuration information and other persistent information.

The dynamic routing database 116 facilitates expedient access to highly dynamic data and frequently used applications. Examples of frequently used applications include the workflows 115 and other applications that may be served up on demand. Examples of highly dynamic data include agent status information (e.g., available, unavailable, status of current task, etc.) and call tasks queued on the unified queue 52.

The unified queue 52 includes tasks corresponding to calls of all interaction types that are waiting for an available non-blended agent 36 or an available blended live-agent 46. The unified queue 52 is implemented as records in a high-performance, in-memory database such as the one provided by TimesTen. Records retrieved from the database may be selected and ordered based on a number of schemes including media type, longest call waiting, customer status, skills required etc.

The administrative manager 122 provides the presentation framework for a user to configure objects in the multimedia customer interaction system 26. The administration manager 122 provides access to objects including adapter configuration data, agent group configuration data, and agent configuration data, workflows 115, tasks, a log of instant message sessions recorded between the customer and the agent, etc.

In case of customer disputes, the administrative manager 122 provides access to the instant message log which enables companies to prove that the customer did indeed make an order and that the agent did provide correct information. Supervisors can view IM logs selectively to evaluate agents and identify training needs.

The routing engine 50 executes exemplary business logic in the form of a workflow 115 in response to receiving a set of parameters and an event from the workflow broker 110. The routing engine 50 processes several types of events including a task arrival/enqueued event, a task dequeued event, a task escalation event, an agent ready for work event, an agent unavailable event, and a reset event. The routing engine 50 utilizes the respective event type and passed parameters to identify and execute of the appropriate workflow 115. The routing engine 50 further utilizes the media type associated with the task arrival and the task escalation events to identify the appropriate workflow 115. The routing engine 50, as directed by the workflow 115, accesses the customer information database 42 and the routing database 54 to obtain information that is utilized to allocate an available agent to a task or queue a task that cannot be allocated to an agent.

The adapter manager 106, message handler 108, task escalation manager 124, workflow broker 110, agent manager 120 and database manager 112 may be embodied as objects that operate as part of the Component Object Model (COM) or the NET Framework, two technologies offered by Microsoft Corporation of Redmond, Wash.

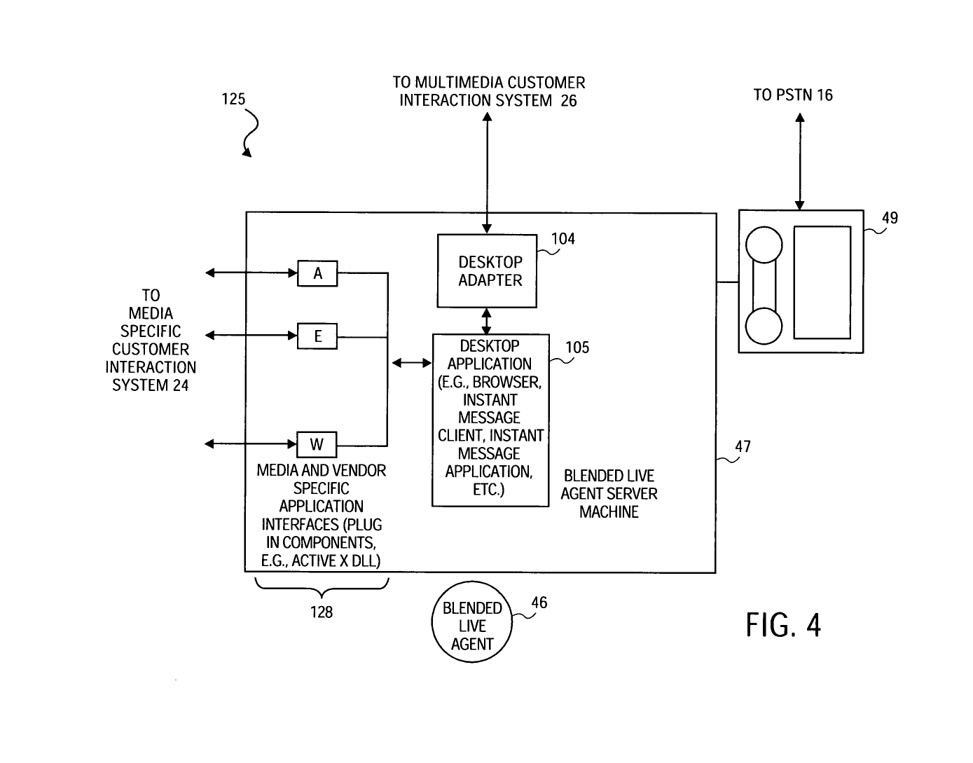

FIG. 4 is a block diagram illustrating a blended live-agent work area 125, according to an exemplary embodiment of the present invention. The blended live-agent 46 is positioned in front of the blended live-agent server machine 47 that includes a desktop application 105. The desktop application 105 utilizes the desktop adapter 104 to communicate an agent available for work message to the multimedia customer interaction system 26 and to receive a task available message from the multimedia customer interaction system 26. Further, the desktop application 105 responds to receiving a task available message from the multimedia customer interaction system 26 by utilizing an application interface 128 that corresponds to a specific media type and vendor to retrieve the corresponding task from the media specific customer interaction system 24. The application interface 128 that may take the form of a plug-in component, such as an Active-X control included in a dynamic link library (DLL) which is a library of executable functions or data that can be used by a Window® application. An Active-X control is software that can be automatically downloaded and executed by a web browser. Active-X is not a programming language, but rather a set of rules for how applications should share information. An Active-X control can be developed in a variety of languages including C, C++, Virtual Basic and Java.

The desktop application 105 may also be embodied as a browser, an instant message client or and instant message application. The blended live agent 46 may utilize the instant message client to communicate instant messages with the caller 12 (the instant message client may be provided by an instant messaging service such as America Online Instant Messenger (AIM®), MSN Messenger® Yahoo's! Messenger®, etc.). In one embodiment, the blended live agent 46 may communicate with the caller 12 by utilizing the same instant message client and instant message service that is utilized by the caller 12. In another embodiment, the blended live agent 46 may communicate with the caller 12 by utilizing an instant message client and instant message service that is different from instant message client and instant message service that is utilized by the caller 12. In yet another embodiment, the desktop application 105 may provide a single consistent instant messaging interface to the blended live agent that is capable of utilizing multiple instant messaging clients and services.

The blended live-agent work area 125 also includes the agent telephone 49 which may be connected to the PSTN 16 and/or the blended live-agent server machine 47.

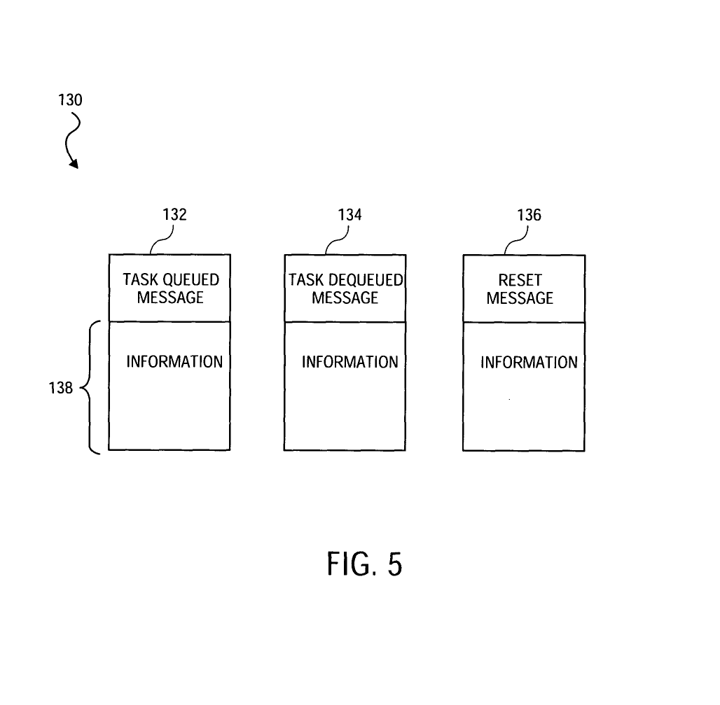

FIG. 5 is a block diagram illustrating task messages 130, according to an exemplary embodiment of the present invention. The task messages 130 include a task queued message 132, a task dequeued message 134, and the reset message 136. Each of the task messages 130 includes an information entry 138 that includes variable information. The task queued message 132 is sent by a media specific customer interaction system 24 to the multimedia customer interaction system 26 to allocate an agent. The task dequeued message 143 is sent from the media specific customer interaction system 24 to the multimedia customer interaction system 26 to dequeue a task in response to the task being allocated to the non-blended agent 36 at the media specific customer interaction system 24 or the blended live-agent 46 at the multimedia customer interaction system 26. The reset message 136 is sent to synchronize the media specific customer interaction system 24 and the multimedia customer interaction system 26 in response to power up or to reestablish communications.

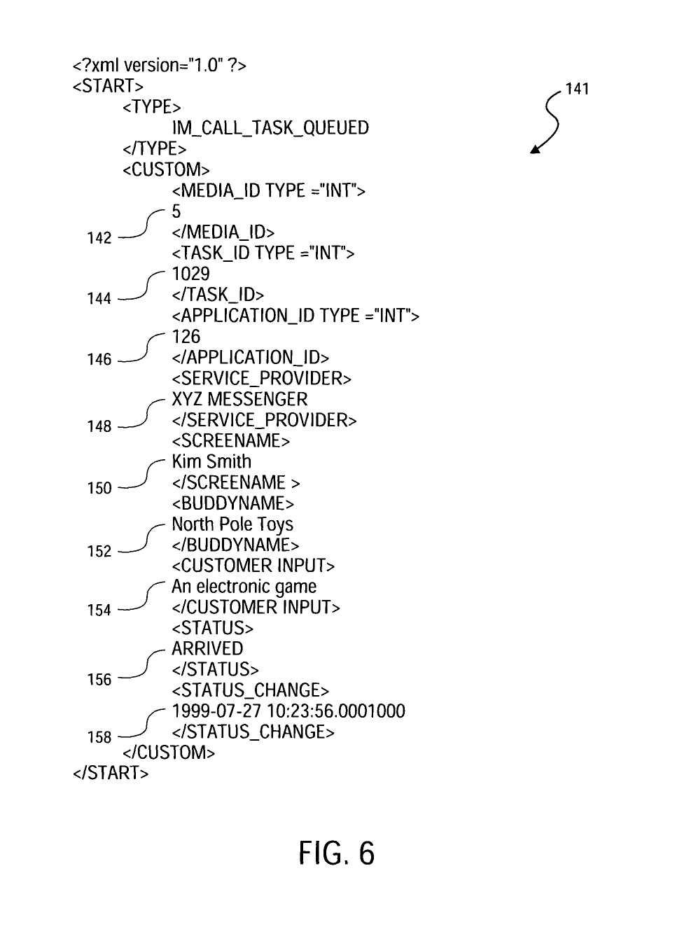

FIG. 6 illustrates the task queued message 132 in the form of an instant message task queued message 141. The task queued message 132 includes exemplary information associated with the instant message call in the form of a media identification type 142 that is utilized to identify the media type of the task (e.g., instant message); a task identification number 144 that is utilized to uniquely identify the present task among other tasks, an application identification number 146 that is utilized to identify the application, subject matter or category of the task; a service provider string 148 that is utilized to identify the instant messaging service provider (e.g., XYZ Messenger); an exemplary caller name in the form of the screen name 150 (e.g., Kim Smith); an exemplary called name in the form of a buddy name 152 (e.g., North Pole Toys); a customer input string 154 as captured by the automated agent 38; a task status 156 (e.g., arrived); and a task time 158.

The task queued message 132 is communicated by the media specific customer interaction system 24 to the multimedia customer interaction 126 to identify an instant message call that requires allocation to a blended live-agent 46 or an automated agent 38.

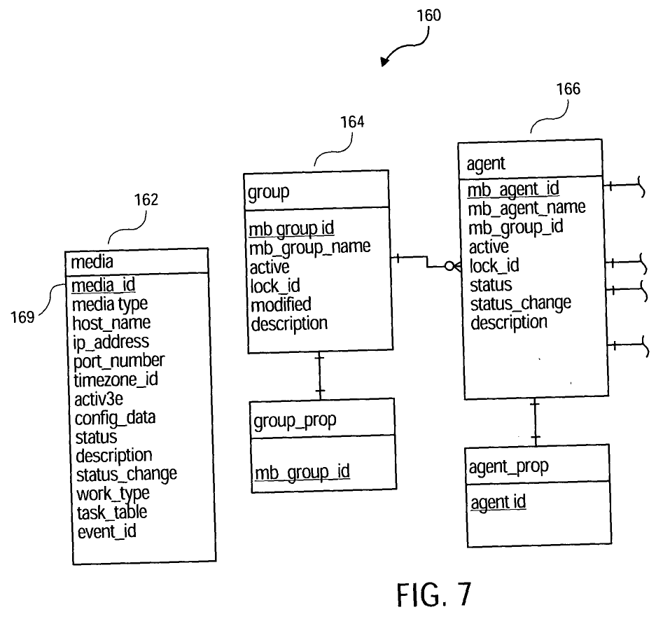

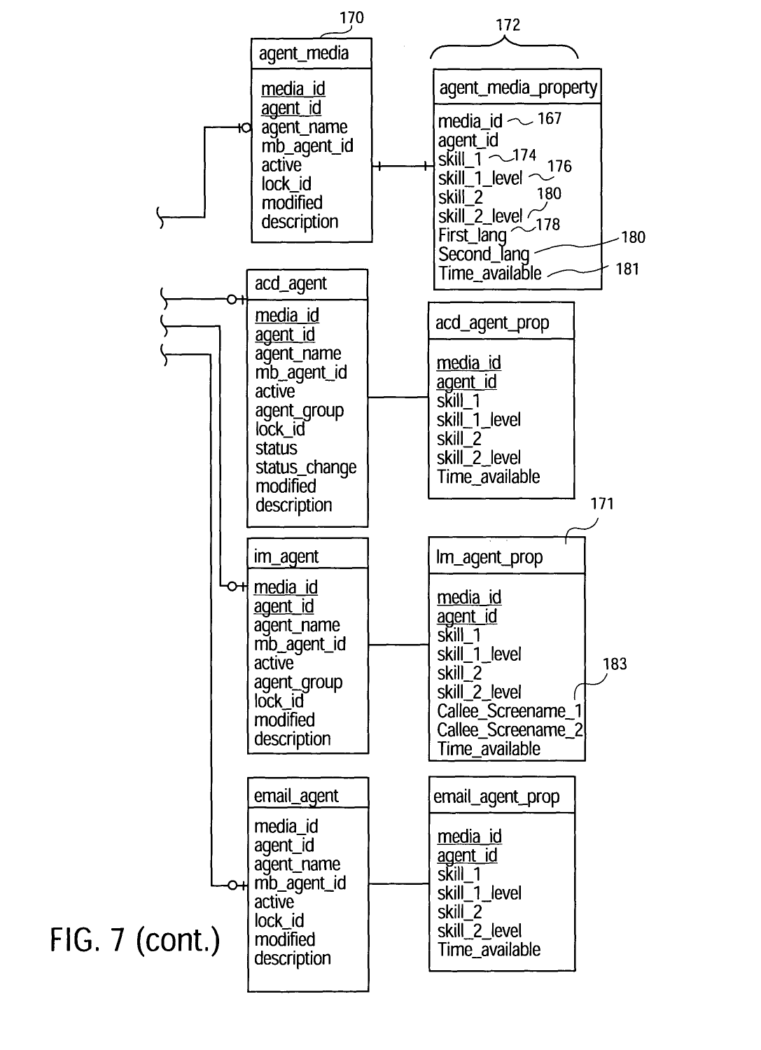

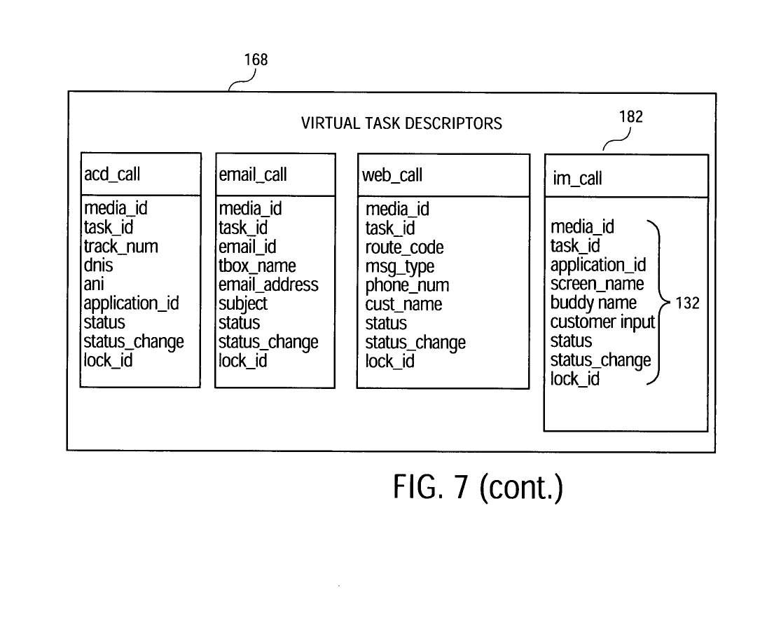

FIG. 7 is an entity relationship diagram illustrating entity relationships, according to an exemplary embodiment of the present invention. An entity is a resource that is utilized by the customer interaction system 14 to process calls and may take the form of a table stored in a database. As previously described, the administrative client machine 44 provides a presentation framework for configuring an entity.

Each entity has a corresponding resource object providing an interface to the entity and its optional associated property table. This architecture allows attributes to be added for each entity with minimal programming effort. The present example illustrates entity tables with corresponding attributes and includes exemplary media information in the form of a media table 162; exemplary agent information in the form a group table 164, an agent table 166, an agent-media table 170, an instant-messaging-agent-property table 171, an agent-media-property table 172; and virtual task descriptors 168.

The media table 162 includes a media identification attribute 169 that identifies a media type and various other attributes associated with a media type.

The group table 164 includes attributes associated with groups of agents. The group table 164 is linked to the agent table 166, which is further linked to the agent-media table 170, which is further linked to the agent-media-property table 172.

The agent-media-property table 172 includes agent attributes that may be customized by a user via the administrative client machine 44. In the present example, the agent-media-property table 172 includes agent skill set information in the exemplary form of a skill attribute 174, agent skill level information in the exemplary form of a skill level attribute 176, a first language attribute 178, a second language attribute 180, and agent availability information in the exemplary form of a time available attribute 181.

The instant-messaging-agent-property table 171 includes attributes for agents that receive instant message calls and are customized by a user via the administrative client machine 44. In the present example, the instant-messaging-agent-property table 171 includes a screenname of an instant message callee in the exemplary form of a callee_screenname_1 183. The callee_screenname_1 183 associates the corresponding agent to a buddy name 152 that is selected by the instant message caller. For example, an instant message caller that selects an instant message screenname of “North Pole Toys—returned items” may be routed to an agent that specializes in returned items for the North Pole Toy Company by associating the agent with the selected screenname via the callee_screenname_1 183 field.

The media table 162, the group table 164, the agent table 166, the agent-media table 170, the instant-messaging-agent-property table 171 and the agent-media-property table 172 are static information and therefore located in the static routing database 114. The virtual task descriptors 168 describe dynamic information and therefore is located in the dynamic routing database 116.

The virtual task descriptors 168 include a task descriptor 182 associated with an instant message call and other media types. The task descriptor 182 includes the same information as previously described in the instant message task queued message 141. Further, the task descriptor 182 may include additional information not included in the instant message task queued message 141. The virtual task descriptors 168 describe individual tasks as they appear on the unified queue 52.

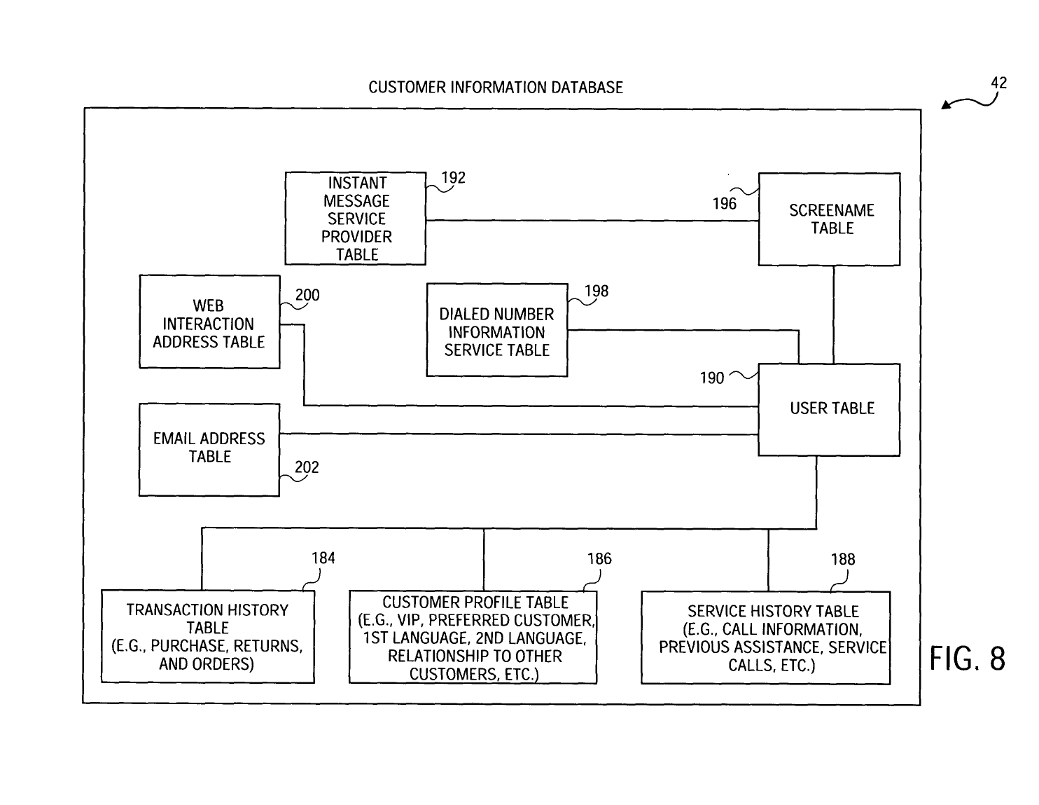

FIG. 8 is a database scheme diagram illustrating tables in the customer information database 42 including transaction information in the exemplary form of a transaction history table 184, customer information in the exemplary form of a customer profile table 186, and call information in the exemplary form a service history table 188, a user table 190, an instant message service provider table 192, a screenname table 196, a dialed number information service table 198, a web interaction address table 200 and an email address table 202. The screenname table 196, the dialed number information service table 198, the web interaction address table 200 and the email address table 202 further include links that converge on the user table 190. The user table 190 includes links branching into the transaction history table 184, the customer profile table 186 and the service history table 188.

Media specific tables provide access to the user table 190 based on the media of the incoming call. For instance an instant message call corresponds to the instant message service provider table 192, which is indexed by utilizing the service provider string 148 to provide a link to the screenname table 196, which is indexed by the screen name 150 of the user to provide a link to the user table 190. In like manner, a web interaction call corresponds to the web interaction address table 200, which is indexed by the web address of the caller to provide a link to the user table 190; a telephone call corresponds to the dialed number information service table 198, which is indexed by the telephone number (e.g., provided by the public switched transport network (PSTN) dialed number information service (DNIS)) of the caller to provide a link to the user table 190; and an email corresponds to the email address table 202, which is indexed by the email address of the sender to provide a link to the user table 190.

The transaction history table 184, the customer profile table 186 and the service history table 188 include database information for a user (e.g., a caller). The transaction history table 184 includes transaction history including orders, purchases, returns, or any other conceivable transaction between the user and the company contacted. The customer profile table 186 includes personal information including a customer status (e.g., new customer, important customer, very important customer or valued customer), a first language, a second language, age, social security number, credit card numbers, etc. The service history table 188 includes service information including call history including assistance offered, any service visits made to the users home or business, warranty information, etc. In particular, the call history information might include the identity of all agents that have provided service to the customer. Thus, the call history information may be used to build a rapport between an agent and a customer by preferentially allocating an agent that has previously serviced the customer.

### Methods

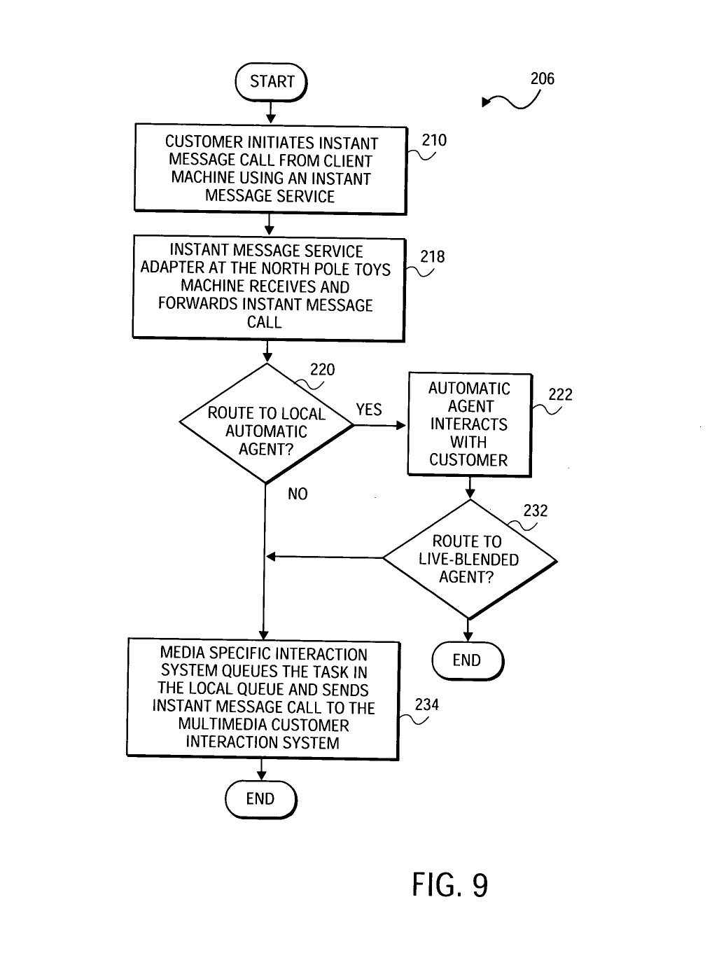

FIG. 9 is a flow chart illustrating a method 206, according to an exemplary embodiment of the present invention, to receive the instant message call at the customer interaction system.

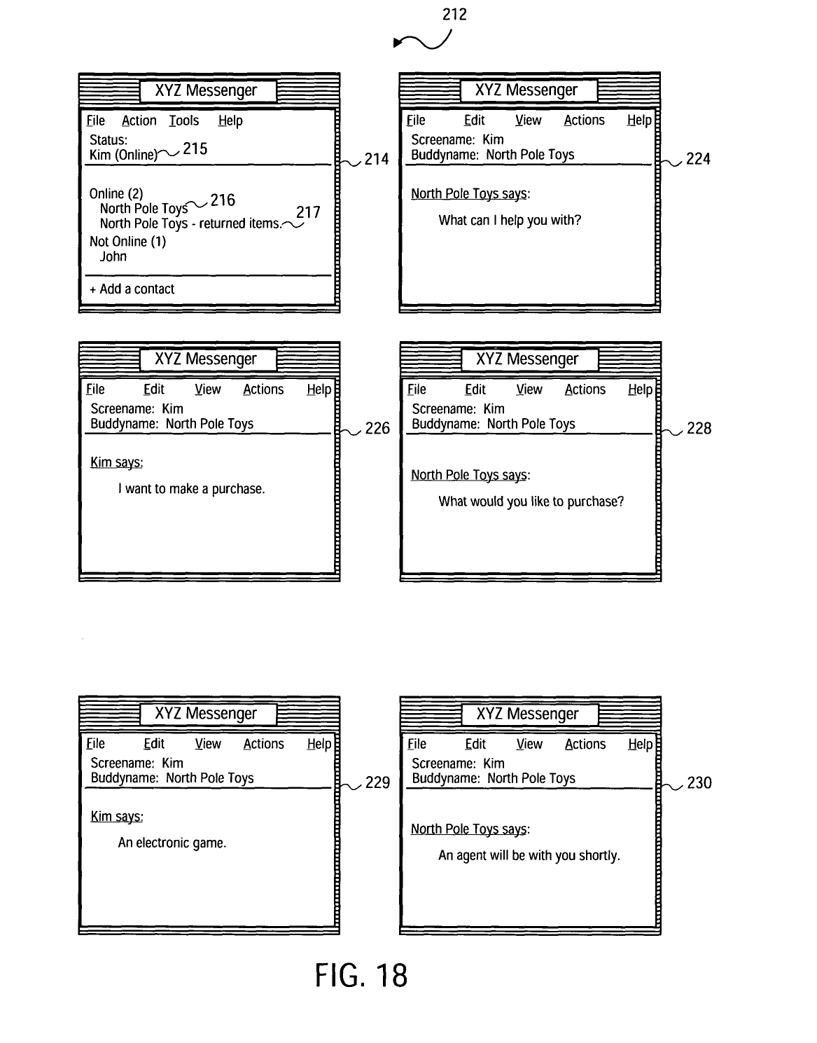

At box 210, the customer initiates an instant message call from the client machine using the XYZ instant messenger service 88. FIG. 18 illustrates an exemplary user interface presented to the instant message caller to access the services provided by the XYZ instant messenger service 88, according to an exemplary embodiment of the present invention. The caller 12 at the client machine 20 is presented with a user interface screen 214 by the XYZ instant message service 88. The name of the caller appears as a screen element 215 in the form of “Kim”, which corresponds to the screen name 150 in the task queue message 132. The caller 12 selects a screen element 216 in the form of “North Pole Toys”, which corresponds to the buddy name 152 in the task queue message 132. Selecting the screen element 216 results in sending a request to the XYZ instant message service 88. In another example, the caller 12 may select a screen element 217 in the form of “North Pole Toys—returned items”, which also results in sending a request to the XYZ instant message service 88 and further signals the nature of the caller's request via the buddy name 152. Returning to FIG. 9, at box 218, the instant message service adapter 92 at the North Pole Toys machine 90 receives and forwards the request to the web interaction server machine 32.

At box 220, the web interaction server machine 32 examines the request and extracts the screen name of the caller (e.g., Kim) to determine whether to route the instant message call to the local automated agent 38. The web interaction server machine 32 may make the determination by accessing the customer information database 42 or the routing database 54 at the multimedia customer interaction machine 40 via the media switch machine 94. For example, Kim's customer profile in the customer profile table 186 may indicate that Kim does not like interacting with computers and prefers a live agent. In another example, the web interaction server machine 32 may determine that a blended live agent 46 is currently not available based on agent information in the routing database 54. In another example, the web interaction server machine 32 may determine that the caller has specified an instant message callee that is dedicated to handling requests regarding a returned item (screen element 217) and forward the instant message call immediately to the multimedia customer interaction system 26 for allocation to a blended live agent 46.

In yet another embodiment the web interaction server machine 32 may not determine whether to forward the instant message call to the multimedia customer interaction system 26; but rather, immediately forward the instant message call to the automated agent 38 where the instant message call is concluded.

In yet another embodiment the web interaction server machine 32 may not determine whether to forward the instant message call to the automated agent 38 and immediately forward the instant message call to the multimedia customer interaction system 26 for allocation to a blended live agent 46.

Returning to the present example, if the interaction server machine 32 determines that the request should be routed to the local automated agent 38 then processing continues at box 222. Otherwise processing continues at box 234.

At box 222, the automated agent 38 interacts with the caller 12 as illustrated in a user interface screen 224 in FIG. 18. For example, at the user interface screen 224 the automated agent 38 prompts the instant message caller, Kim, by requesting, “What can I help you with?” At a user interface screen 226 Kim responds, “I want to make a purchase.” At a user interface screen 228 the automated agent 38 probes the nature of Kim's request by asking, “What would you like to purchase?” At a user interface screen 229 Kim responds, “An electronic game.” In response, the automated agent 38 determines that assistance with a live agent will be required and responds to Kim at a user interface screen 230 by replying, “An agent will be with you shortly”. Other examples may include different questions and responses. For instance Kim may request that she be immediately forwarded to a live agent thus limiting her interaction with the automated agent 38. In another example, the automated agent 38 may acquire additional information before forwarding the instant message call to the blended live-agent 46 by asking questions pertaining to electronic games (e.g., the name of the manufacturer, the subject matter of the game, the name of the game, etc.).

Returning to FIG. 9, at box 232, the non-blended auto-agent server machine 96 determines if the caller 12 should be routed to the blended live-agent 46. The non-blended auto-agent server machine 96 makes this determination by accessing and executing applications including workflows 115 and accessing databases including the routing database 54 and the customer information database 42 at the multimedia customer interaction machine 40. Further, the non-blended auto-agent server machine 96 records instant message call information that is acquired during the interaction with the caller 12. For example, Kim's reply, “An electronic game” is recorded and corresponds to the customer input string 154 in the task queue message 132. In addition, the non-blended auto-agent server machine 96 associates Kim's request for an electronic game to an application identification number 146 that is subsequently recorded in the instant message task queue message 141. If the non-blended auto-agent server machine 96 determines that the caller should be routed to a blended live-agent 46 then processing continues at box 234. Otherwise processing ends after the automated agent 38 and the caller 12 complete the instant message call.

At box 234, the web interaction server machine 32 communicates the request to the web interaction adapter 98 at the media switch machine 94. The web interaction adapter 98 converts the request into the standard form of the instant message task queued message 141. The web interaction adapter 98 forwards the instant message task queue message 141 to the adapter manager 106 in the multimedia customer interaction system 26. Also, the web interaction server machine 32 queues the instant message call in the media specific queue 34 at the web interaction server machine 32.

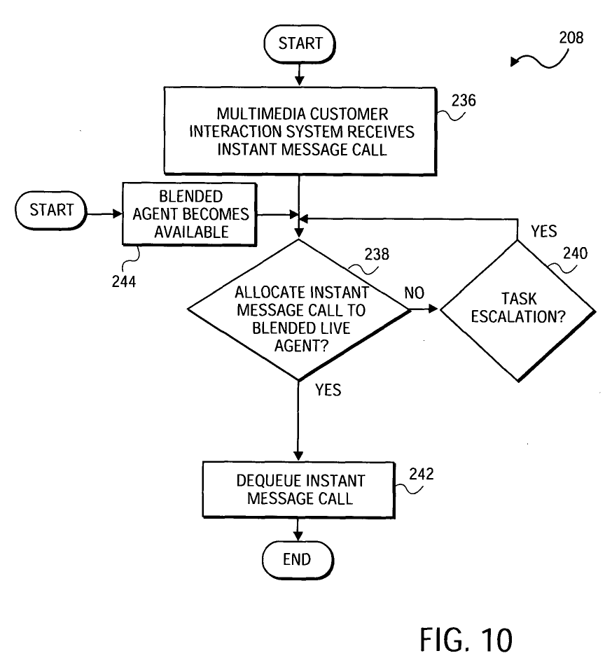

FIG. 10 is a flow chart illustrating a method 208, according to an exemplary embodiment of the present invention, to process an instant message call within the customer interaction system, blended or commingled with other interaction types. For example, the embodiment described below describes processing an instant message task queued message 141; however, other interactions types may be similarly processed.

At box 236, the multimedia customer interaction engine 48 receives the instant message call in the form of an instant message task queued message 141. Processing continues at decision box 238.

At decision box 238, the multimedia customer interaction system 26 executes the workflow 115 to allocate the instant message task to a blended live-agent 46. If the allocation is successful, the blended live-agent server machine 47 retrieves the instant message task from the web interaction server machine 32 and processing continues at box 242. Otherwise, the task is queued in the unified queue 52 with a scheduled timeout and processing continues at decision box 240.

At decision box 240, upon timeout, the task escalation manager 124 escalates the instant message task and a branch is made to decision box 238. Otherwise, the instant message task remains queued at decision box 240 waiting for task escalation or for a blended live-agent to become available as illustrated in box 244.

At box 242, the instant message task is dequeued from the unified queue 52 at the multimedia customer interaction machine 40. The multimedia customer interaction machine 40 dequeues the instant message call in response to receiving the task dequeued message 134 from the web interaction server machine 32. The web interaction server machine 32 communicates the task dequeued message 134 in response to receiving a request to retrieve the instant message call from the blended live-agent server machine 47. Further, the web interaction server machine 32 removes the instant message call from the media specific queue 34.

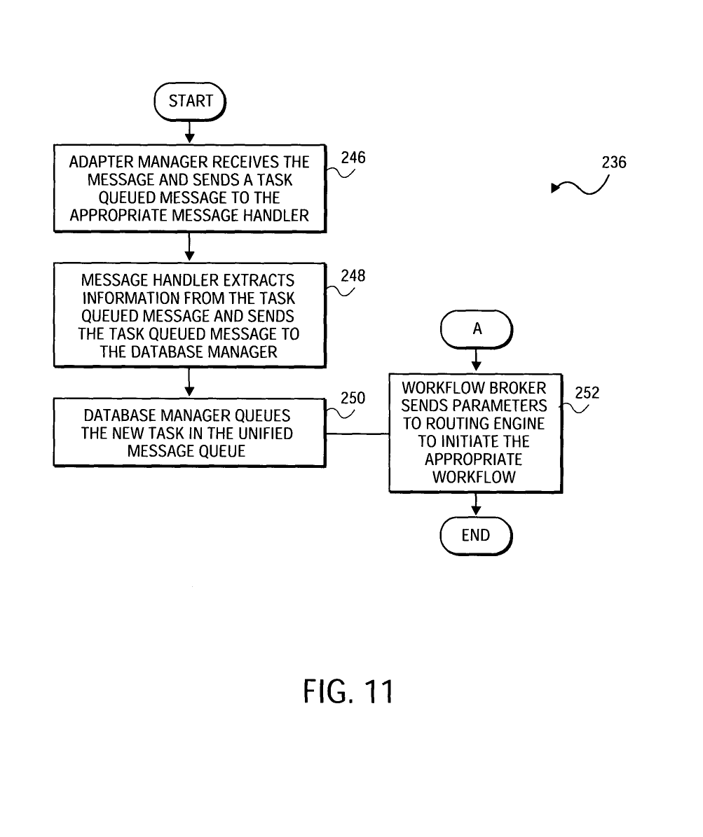

FIG. 11 is a flow chart illustrating the method 236, according to an exemplary embodiment of the present invention, to receive an instant message call at the multimedia customer interaction machine 40. At box 246, the adapter manager 106 receives the instant message task queue message 141 for the instant message call and forwards it to the message handler 108.

At box 248, the message handler 108 extracts information from the instant message task queue message 141 in the form of parameters and sends the instant message task queue message 141 to the database manager 112.

At box 250, the database manager 112 responds to receipt of the instant message task queued message 141 by queuing an instant message task in the unified message queue 52.

At box 252, the message handler 108 communicates parameters associated with the instant message task to the workflow broker 110 which in turn communicates the parameters associated with the instant message task to the routing engine 50. The routing engine 50 utilizes the parameters to identify and then execute the appropriate workflow.

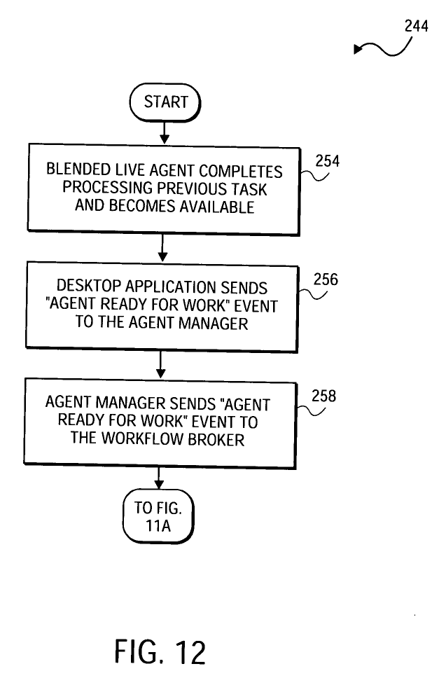

FIG. 12 is a flow chart illustrating a method 244, according to an exemplary embodiment of the present invention, to process a blended live-agent 46 that becomes available to work on a task.

At box 254, the blended live-agent 46 seated in front of the blended live-agent server machine 47 completes a task and becomes available.

At box 256, in response to the agent becoming available, the desktop application 105 sends an agent ready for work event to the agent manager 120. The agent ready for work event may be automatically communicated to the agent manager 120 in response to the blended live-agent 46 completing a task. In another embodiment the agent ready for work event may be communicated in response to the blended live-agent 46 indicating availability by selecting a button on a screen displayed on the blended live-agent server machine 47.

At box 258, the agent manager 128 communicates an agent ready for work event to the workflow broker 110. Processing continues as previously described at the entry point marked “A” on FIG. 11.

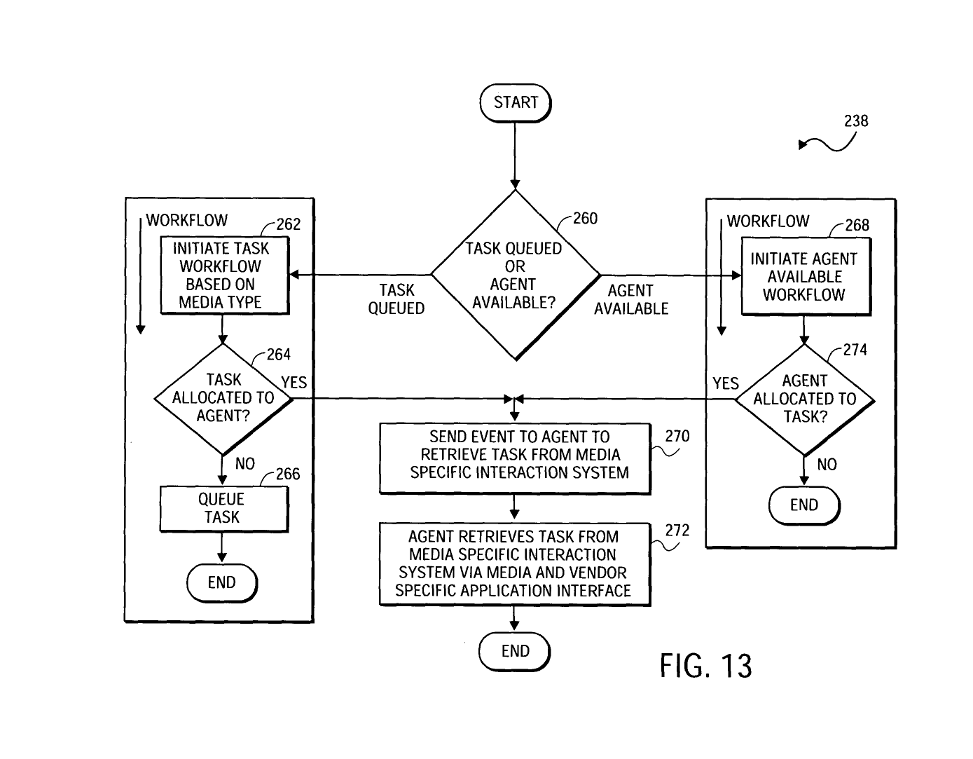

FIG. 13 is a flow chart illustrating the method 238, according to an exemplary embodiment of the present invention, to allocate the instant message call to a blended live-agent.

At decision box 260, the routing engine 50 receives parameters from the workflow broker 110 that are utilized to identify the appropriate workflow. If the routing engine 50 determines that a new task has arrived or a previously queued task has been escalated, then processing continues at box 262. Otherwise, processing continues at box 268.

At box 262, a workflow for the task is selected based on parameters passed from the workflow broker 110 and the media type of the task and processing continues at decision box 264.

At decision box 264, the routing engine 50 determines if an agent may be allocated to the task. If an agent may be allocated, then processing continues at box 270. Otherwise the task is queued at box 266.

At box 268, a workflow for the available agent is selected and processing continues at decision box 274.

At decision box 274, the routing engine 50 determines if a task may be allocated to the available agent. If a task may be allocated, then processing continues at box 270. Otherwise processing ends.

At box 270, the routing engine 50 communicates an event to the agent manager 120 via the workflow broker 110 to retrieve the instant message task from the web interaction server machine 32.

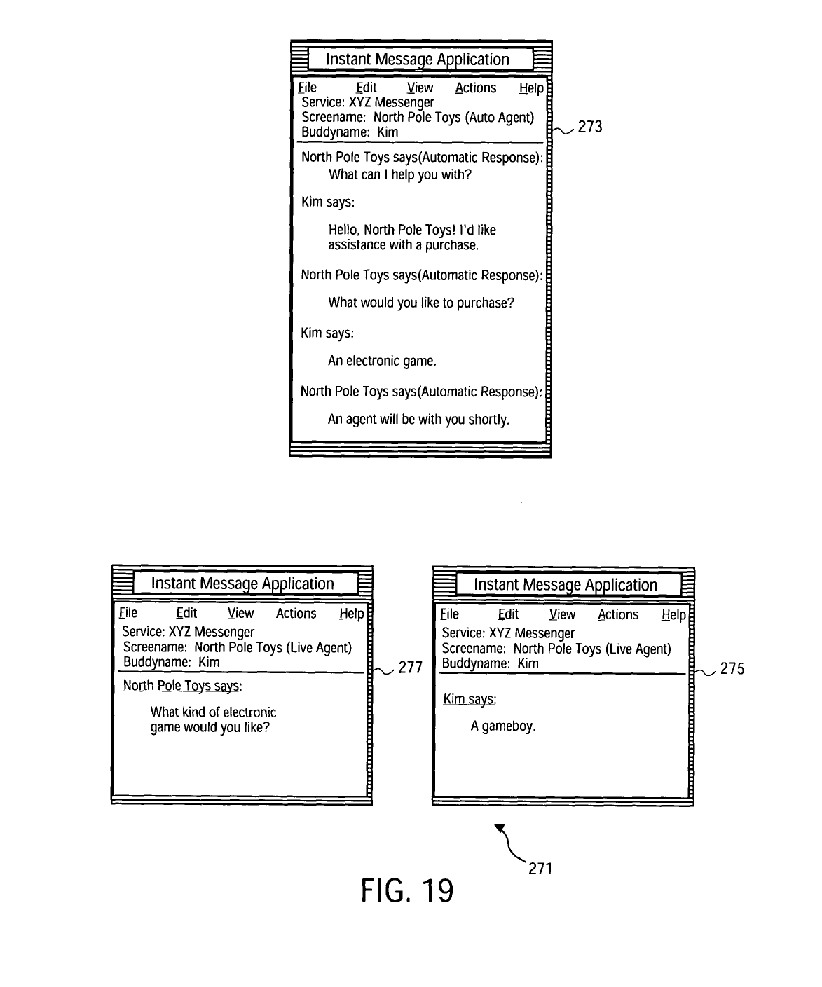

At box 272, the desktop application 105 on the blended live-agent server machine 47 retrieves the allocated task from the web interaction server machine 32. The retrieved task would appear to the blended live-agent 47 as user interface screens 271 in FIG. 19. For example, a user interface screen 273 presents the previously recorded interaction between the caller 12 and the automated agent 38 in the form of a screen-pop. Thus, the blended live-agent 46 may continue interacting with the caller 12 after reviewing the previously recorded questions and responses. For example, the user interface screen 277 illustrates that the blended live-agent 47 continues interacting with the caller 12 by asking the question, “What kind of electronic game would you like?” In response, the user interface screen 275 illustrates the caller 12 responding, “A gameboy”. In other embodiments, other information may be displayed to the blended live-agent 46 which may include any information associated with the instant message call.

Returning to FIG. 13 and box 272, the web interaction server machine 32 further responds to the task retrieval by communicating a task dequeued message 134 to the multimedia customer interaction engine 48 which responds by dequeing the instant message task from the unified queue 52.

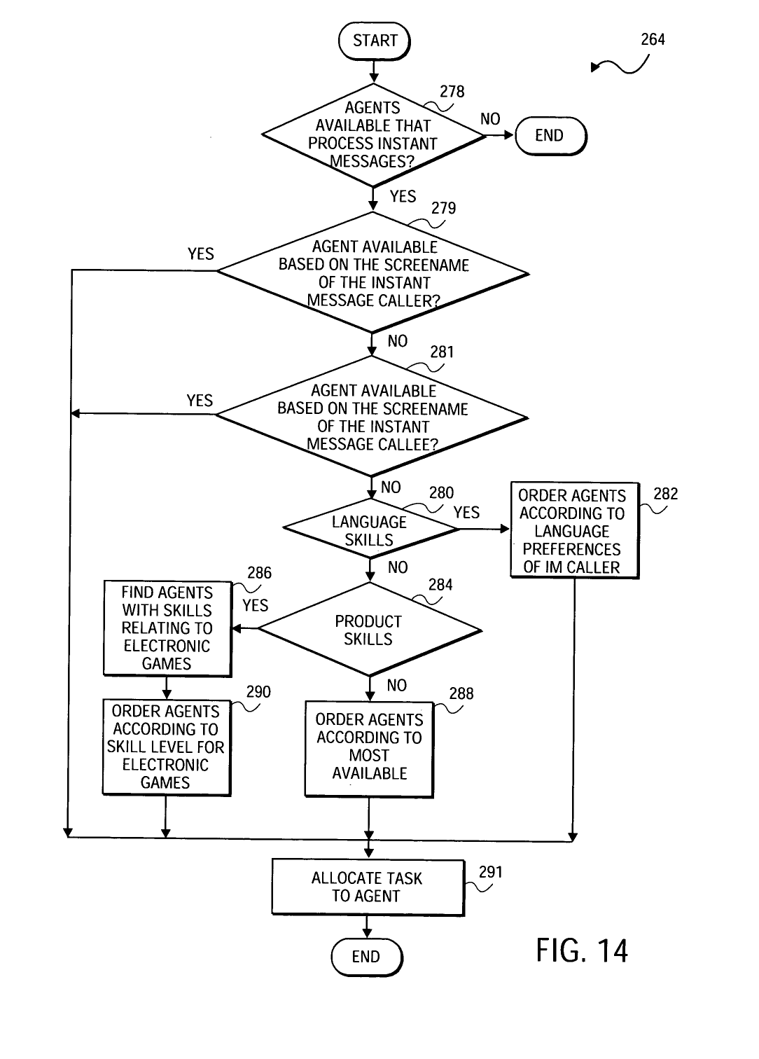

FIG. 14 is a flow chart illustrating a method 264, according to an exemplary embodiment of the present invention, to allocate an agent to a task in the form of a task workflow.

At decision box 278, the routing engine 50 reads the routing database 54 to determine if agents are available to process the instant message call type. If agents are available, then processing continues at decision box 280. Otherwise processing ends.

At decision box 279, the routing engine 50 accesses the screen name 150 in the instant message task queued message 141 to access the caller's call history information in the service history table 188. If the routing engine 50 determines that an agent that has previously provided service to the customer is available then processing continues at box 291. Otherwise processing continues at decision box 281.

At decision box 281, the routing engine 50 compares the buddy name 152 in the instant message task queued message 141 with the callee_screenname_1 183 field in the instant messaging agent property table 171 for each available agent. If the routing engine 50 determines that an agent is associated with the buddy name 152 selected by the customer then processing continues at box 291. Otherwise processing continues at decision box 280.

At decision box 280, the routing engine 50 accesses the service provider string 148 and screen name 150 in the instant message task queued message 141 to access the customer profile table 186 in the customer information database 42 to determine if the caller 12 requires a blended live-agent 46 with language skills. If language skills are required, then processing continues at box 282. Otherwise processing continues at decision box 284.

At box 282, the routing engine 50 orders selected agents according to the language preferences of the instant message caller. For example, if the first language of the instant message caller is Spanish and the second language is English, then blended live-agents 46 with Spanish and English language skills are identified and ordered as more desirable for allocation. The routing engine 50 identifies language skills associated with the each blended live-agent 46 by reading the first language attribute 178 and the second language attribute 180 in the agent-media-property table 172. Next, the routing engine 50 orders those agents with language skills as more preferable for allocation to the task over those agents without such skills.

At decision box 284, the routing engine 50 examines the application identification number 146 and the customer input string 154 in the instant message task queue message 141 to determine if a blended live-agent 46 with product skills is desirable. In the present example, the application identification number 126 and the customer input string 154 indicate that skills pertaining to “electronic games” are desirable and processing continues at box 286. Otherwise processing continues at box 288.

At box 286, the routing engine 50 utilizes the routing database 54 to find agents with skills relating to electronic games. For example, the routing engine 50 may utilize the skill attribute 174 to identify a blended live-agent 46 with the desired skill. Processing continues at box 290 after agents are identified.

At box 290, the routing engine 50 orders the identified blended live-agents 46 based on level of skill with regard to electronic games. For example, the routing engine 50 may utilize the skill level attribute 176 in the routing database 54 to determine the skill level of the blended live-agent 46.

At box 288, the routing engine 50 orders the agents based on agent availability (e.g., the agent that has waited longest for a task) by referencing the time available attribute 181 in the agent-media-property table 172.

At box 291, the task is allocated to the most desirable agent and the workflow terminates.

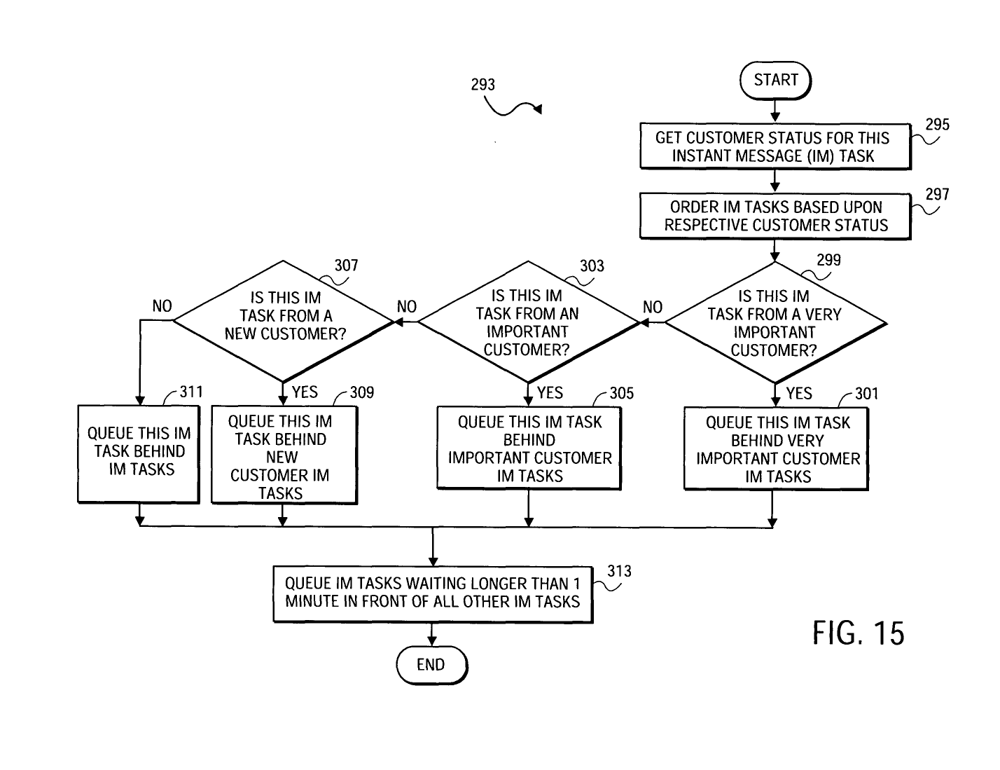

FIG. 15 is a flow chart illustrating a method 293, according to an exemplary embodiment of the present invention, to queue a task in the form of a workflow.

At box 295, the routing engine 50 determines the customer status for the present instant message task by utilizing the screen name 150 (e.g., Kim Smith) to access the customer information database 42 including the customer's transaction history table 184, the customer profile table 186, and the customer service history table 188. A number of algorithms may be utilized to determine the customer status. Algorithms may analyze purchases, returns, orders, etc. (e.g., information in the transaction history table 184), customer profile status, the relationship of the customer with other customers, desirable marketing groups inclusive of the customer, etc. (e.g., information in the customer profile table 186) or previous call information, previous service visits, etc. (e.g., information in the service history table 188). In the present example the analysis yields a customer status of “Very Important”, “Important”, “New” or “Valued” though the number of statuses and their meaning may vary in different embodiments.

At box 297, the routing engine 50 orders the instant message tasks on the unified queue 52 according to the customer status for each instant message task.

At decision box 299, the routing engine 50 determines if the present instant message task has a very important customer status. If the customer status is very important then processing continues at box 301. Otherwise processing continues at decision box 303.

At decision box 303, the routing engine 50 determines if the present instant message task has an important customer status. If the customer status is important, then processing continues at box 305. Otherwise processing continues at decision box 307.

At decision box 307, the routing engine 50 determines if the present instant message task has a new customer status. If the customer is new, then processing continues at box 309. Otherwise processing continues at box 311.

At box 301, the routing engine 50 queues the present instant message task behind other instant message tasks with a customer status of very important.

At box 305, the routing engine 50 queues the present instant message task behind other instant message tasks with a customer status of important.

At box 309, the routing engine 50 queues the present instant message task behind other instant message tasks with a customer status of new.

At box 311, the routing engine 50 queues the present instant message task behind other instant message tasks.

At box 313, the routing engine 50 prioritizes the instant message call based upon the age of an already queued instant message call by identifying all instant message tasks waiting longer than one minute and queuing them in front of all other instant message tasks.

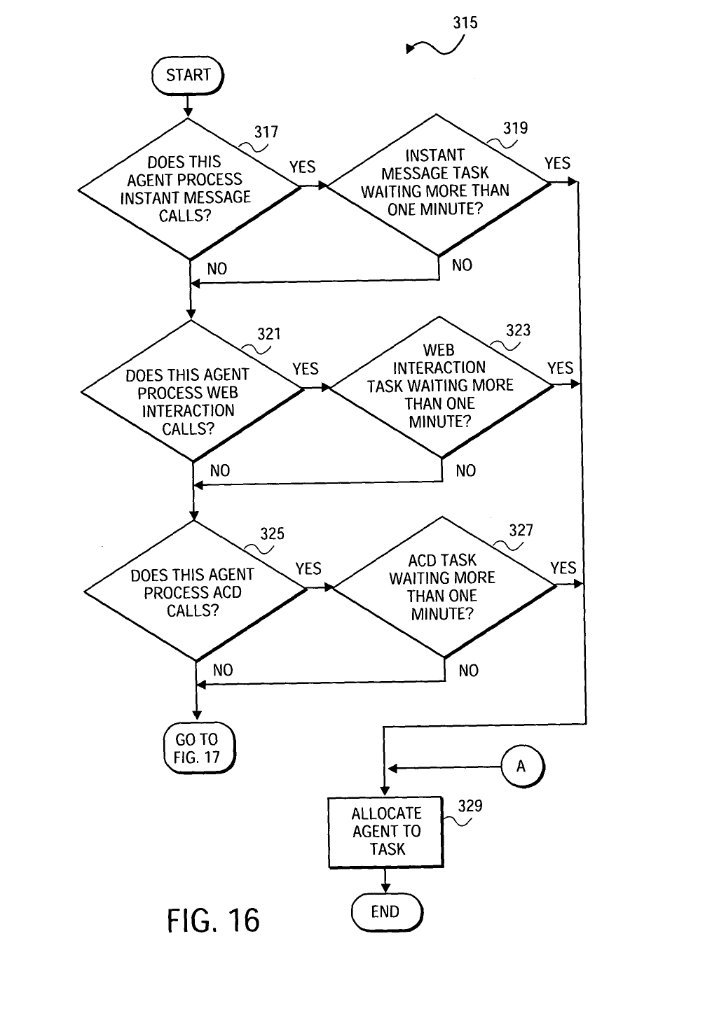

FIG. 16 is a flow chart illustrating a method 315, according to an exemplary embodiment of the present invention, to allocate an agent available for work to a task in the form of a workflow.

At decision box 317, the routing engine 50 determines if the available blended live-agent 46 processes instant message calls by accessing the media identification entry 169 in the agent-media property table 172 associated with the available blended live-agent 46. If the blended live-agent 46 processes instant message calls then processing continues at decision box 319. Otherwise processing continues at decision box 321.

At decision box 319, the routing engine 50 determines if an instant message task has been waiting more than one minute. If an instant message task has been waiting more than one minute then processing continues at box 329. Otherwise processing continues at decision box 321.

At decision box 321, the routing engine 50 determines if the available blended live-agent 46 processes web interaction calls. If the available blended live-agent 46 processes web interaction calls, then processing continues at decision box 323. Otherwise processing continues at decision box 325.

At decision box 323, the routing engine 50 determines if a web interaction task has been waiting for more than one minute. If a web interaction task has been waiting for more than one minute, then processing continues at box 329. Otherwise processing continues at decision box 325.

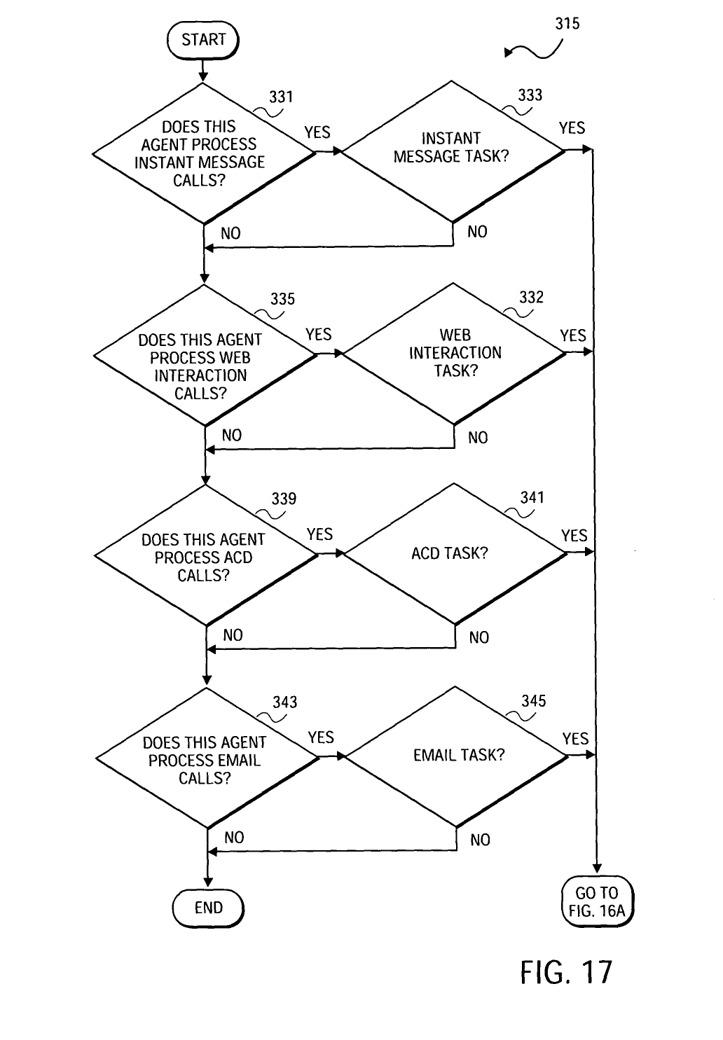

At decision box 325, the routing engine 50 determines if the available blended live-agent 46 processes ACD calls. If the available blended live-agent 46 processes ACD calls, then processing continues at decision box 329. Otherwise, processing continues at “START” on FIG. 17.

At decision box 327, the routing engine 50 determines if an ACD task has been waiting more than one minute. If an ACD task has been waiting for more than one minute, then processing continues at box 329. Otherwise processing continues at “START” on FIG. 17.

At box 329, the routing engine 50 allocates the agent to the identified task and ends.

FIG. 17 is a flowchart illustrating a method 315, according to an exemplary embodiment of the present invention, to allocate an available agent to a queued task in the form the agent available workflow.

At decision box 331, the routing engine 50 determines if the available blended live-agent 46 processes instant message calls. If the available blended live-agent 46 processes instant messages calls, then processing continues at decision box 333. Otherwise, processing continues at decision box 335.

At decision box 333, the routing engine 50 determines if an instant message task is queued. If an instant message task is queued, then processing continues at “A” on FIG. 17. Otherwise, processing continues at decision box 335.

At decision box 335, the routing engine 50 determines if the available blended live-agent 46 processes web interaction calls. If the available blended live-agent 46 processes web interaction calls, then processing continues at decision box 332. Otherwise processing continues at decision box 339.

At decision box 332, the routing engine 50 determines if a web interaction task is queued. If a web interaction task is queued, then processing continues at entry “A” on FIG. 16. Otherwise, processing continues at decision box 339.

At decision box 339, the routing engine 50 determines if the available blended live-agent 46 processes ACD calls. If the available blended live-agent 46 processes ACD calls, then processing continues at decision box 341. Otherwise processing continues at decision box 343.

At decision box 341, the routing engine 50 determines if an ACD task is queued. If the routing engine 50 determines that an ACD task is queued, then processing continues at entry “A” on FIG. 16. Otherwise, processing continues at box 343.

At decision box 343, the routing engine 50 determines if the available blended live-agent 46 processes email calls. If the blended live-agent 46 processes email calls, then processing continues at decision box 345. Otherwise processing ends.

At decision box 345 routing engine 50 determines if an email task is queued. If an email task is queued, then processing continues at entry “A” on FIG. 16. Otherwise, processing ends.

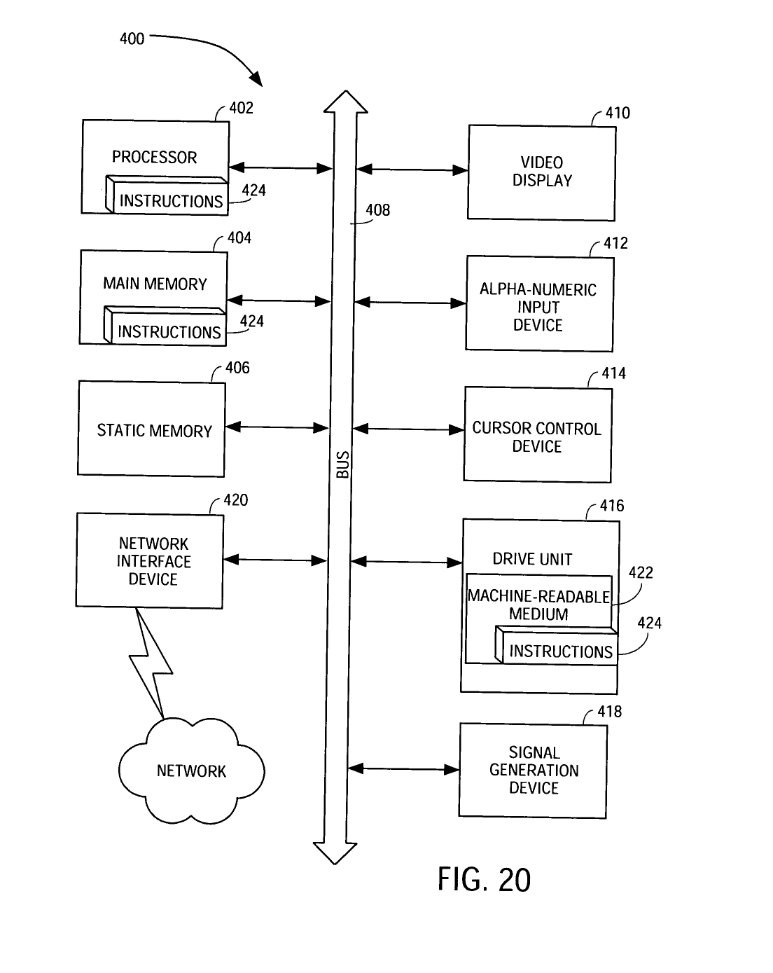

FIG. 20 illustrates a diagrammatic representation of machine in the exemplary form of a computer system 400 within which a set of instructions, for causing the machine to perform any one or more of the methodologies discussed herein, may be executed. In alternative embodiments, the machine operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 400 includes a processor 402 (e.g., a central processing unit (CPU) a graphics processing unit (GPU) or both), a main memory 404 and a static memory 406, which communicate with each other via a bus 408. The computer system 400 may further include a video display unit 410 (e.g., a liquid crystal display (LCD) or a cathode ray tube (CRT)). The computer system 400 also includes an alpha-numeric input device 412 (e.g., a keyboard), a pointer device 414 (e.g., a mouse), a disk drive unit 416, a signal generation device 418 (e.g., a speaker) and a network interface device 420.

The disk drive unit 416 includes a machine-readable medium 422 on which is stored one or more sets of instructions (e.g., software 424) embodying any one or more of the methodologies or functions described herein. The software 424 may also reside, completely or at least partially, within the main memory 404 and/or within the processor 402 during execution thereof by the computer system 400, the main memory 404 and the processor 402 also constituting machine-readable media.

The software 424 may further be transmitted or received over a network 426 via the network interface device 420.

While the machine-readable medium 492 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to included, but not be limited to, solid-state memories, optical and magnetic media, and carrier wave signals.

Thus, a method and system to process an instant message call within a customer interaction system have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

1. A method to process an instant message call within a customer interaction system, the method including:
receiving the instant message call at the customer interaction system; and
processing the instant message call within the customer interaction system with other interaction types based on information associated with the instant message call.

2. The method of claim 1, wherein the receiving of the instant message call at the customer interaction system includes allocating the instant message call to an automated agent for response.

3. The method of claim 2, wherein the customer interaction system forwards the instant message call to a live agent based on an at least one of an instant message caller response to the automated agent and an identity of an instant message caller.

4. The method of claim 1, wherein the processing includes allocating the instant message call to a live agent for response.

5. The method of claim 4, wherein the allocating includes selecting the live agent based on a screenname of an instant message callee.

6. The method of claim 4, wherein the allocating includes selecting the live agent based on a screenname of an instant message caller.

7. The method of claim 6, wherein the allocating includes selecting the live agent based on information about the instant message caller.

8. The method of claim 7, wherein information about the instant message caller includes call history information that indicates the selected live agent has previously provided service to the instant message caller.

9. The method of claim 4, wherein the allocating includes selecting the live agent based on at least one of an agent skill set and an agent skill level.

10. The method of claim 4, wherein the allocating includes selecting the live agent based on an agent availability.

11. The method of claim 4, wherein the allocating includes selecting the live agent based on an instant message caller response to the automated agent.

12. The method of claim 11, wherein the instant message caller response includes a preference for a live agent.

13. The method of claim 4, wherein the allocating of the instant message call includes causing a screen to appear to the live agent that includes information associated with the instant message call.

14. The method of claim 1, wherein the processing includes queuing the instant message call within a unified message queue that includes other interaction types.

15. The method of claim 14, wherein the queuing includes prioritizing the instant message call based upon a customer status associated with the instant message call.

16. The method of claim 15, wherein the customer status is determined by a prior purchase made by an instant message caller.

17. The method of claim 14, wherein the queuing includes prioritizing the instant message call based upon a customer status of an already queued instant message call.

18. The method of claim 14, wherein the queuing includes prioritizing the instant message call based on an age of an already queued instant message call.

19. The method of claim 1, wherein the processing includes executing business logic.

20. The method of claim 19, wherein the executing of the business logic includes accessing a database that includes customer information.

21. The method of claim 20, wherein the customer information includes transaction information.

22. The method of claim 21, wherein the transaction information includes order history information.

23. The method of claim 21, wherein the transaction information includes service history information.

24. The method of claim 19, wherein the executing of the business logic includes accessing a database that includes agent information.

25. The method of claim 19, wherein the executing of the business logic includes accessing a database that includes call information.

26. The method of claim 19, wherein the executing of the business logic includes accessing a database that includes media information.

27. The method of claim 1, wherein the information associated with the instant message call includes identification information identifying the instant message caller.

28. The method of claim 27, wherein the identification information includes at least one of a screen name of the instant message caller, a screen name of the instant message callee and an instant message service provider name.

29. The method of claim 1, wherein processing includes retrieving an instant message log which includes the instant message call between an agent and a customer.

30. A system to process an instant message call within a customer interaction system, the system including:
a media specific customer interaction system to receive the instant message call at the customer interaction system; and
a multimedia customer interaction system to process the instant message call within the customer interaction system with other interaction types based on information associated with the instant message call.

31. The system of claim 31, wherein the media specific customer interaction system allocates the instant message call to an automated agent for response.

32. The system of claim 31, wherein the media specific customer interaction system forwards the instant message call to a live agent based on an at least one of an instant message caller response to the automated agent and an identity of an instant message caller.

33. The system of claim 30, wherein to process the instant message call the multimedia customer interaction system allocates the instant message call to an agent for response.

34. The system of claim 33, wherein the multimedia customer interaction system allocates the live agent based on a screenname of an instant message callee.

35. The system of claim 33, wherein the multimedia customer interaction system allocates the live agent based on a screenname of an instant message caller.

36. The system of claim 35, wherein the multimedia customer interaction system allocates the live agent based on information about the instant message caller.

37. The system of claim 36, wherein information about the caller includes call history information that indicates the live agent has previously provided service to the instant message caller.

38. The system of claim 33, wherein the multimedia customer interaction system allocates the live agent based on at least one of an agent skill set and an agent skill level.

39. The system of claim 33, wherein the multimedia customer interaction system allocates the live agent based on an agent availability.

40. The system of claim 33, wherein the multimedia customer interaction system allocates the live agent based on an instant message caller response to the automated agent.

41. The system of claim 40, wherein the instant message caller response includes a preference for a live agent.

42. The system of claim 33, wherein the multimedia customer interaction system allocates the instant message call by causing a screen to appear to the agent that includes information associated with the instant message call.

43. The system of claim 30, wherein the multimedia customer interaction system processes the instant message call by queuing the instant message call in a unified message queue that includes other interaction types.

44. The system of claim 43, wherein the multimedia customer interaction system queues the instant message call by prioritizing the instant message call based on a customer status associated with the instant message call.

45. The system of claim 44, wherein the customer status is determined by a purchase made by an instant message caller.

46. The system of claim 43, wherein the multimedia customer interaction system queues the instant message call by prioritizing the instant message call based on a customer status of an already queued instant message call.

47. The system of claim 43, wherein the multimedia customer interaction system queues the instant message call by prioritizing the instant message call based on an age of an already queued instant message call.

48. The system of claim 30, wherein the multimedia customer interaction system processes the instant message call by executing business logic.

49. The system of claim 48, wherein the multimedia customer interaction system executes the business logic that accesses a database that includes customer information.

50. The system of claim 49, wherein the customer information includes transaction information.

51. The system of claim 50, wherein the transaction information includes order history information.

52. The system of claim 50, wherein the transaction information includes service history information.

53. The system of claim 48, wherein the multimedia customer interaction system executes the business logic that accesses a database that includes agent information.

54. The system of claim 48, wherein the multimedia customer interaction system executes the business logic that accesses a database that includes call information.

55. The system of claim 48, wherein the multimedia customer interaction system executes the business logic that accesses a database that includes media information.

56. The system of claim 30, wherein the information associated with the instant message call includes identification information identifying the instant message caller.

57. The system of claim 56, wherein the identification information includes at least one of a screen name of the instant message caller, a screen name of the instant message callee and an instant message service provider name.

58. The system of claim 30, further including an administrative manager to retrieve an instant message log which includes the instant message call between an agent and a customer.

59. A machine readable medium storing a set of instructions that, when executed by the machine, cause the machine to:
receive the instant message call at the customer interaction system; and
process the instant message call within the customer interaction system with other interaction types based on information associated with the instant message call.

60. A system to process an instant message call within a customer interaction system, the system including:
a first means for receiving the instant message call at the customer interaction system; and
a second means for processing the instant message call within the customer interaction system with other interaction types based on information associated with the instant message call.
